(19) United States
(12) Patent Application Publication
(10) Pub. No.: US 2021/0062558 A1
(43) Pub. Date: Mar. 4, 2021

(54) MOTOR VEHICLE HANDLE ASSEMBLY AND METHOD FOR ASSEMBLING SUCH A MOTOR VEHICLE HANDLE ASSEMBLY

(71) Applicant: HUF HÜLSBECK & FÜRST GMBH CO.KG, Velbert (DE)

(72) Inventor: Andreas Beck, Bochum (DE)

(73) Assignee: HUF HÜLSBECK & FÜRST GMBH CO.KG, Velbert (DE)

(21) Appl. No.: 16/958,051

(22) PCT Filed: Nov. 9, 2018
(86) PCT No.: PCT/EP2018/080809

§ 371 Date: Jun. 25, 2020

(30) Foreign Application Priority Data
Jan. 12, 2018 (DE) 10 2018 100 654.3

(51) Int. Cl. E05B 85/18; E05B 79/06; E05B 85/06

(52) U.S. Cl. CPC E05B 85/18; E05B 81/76; E05B 85/06; E05B 79/06

(57) ABSTRACT

A motor vehicle handle assembly includes a bearing bracket, a recess housing with a receiving area, a handle element which is attached to pivot arms, and a closing cylinder which extends in the receiving area. The pivot arms are rotationally fixed to a bearing axis which is rotatably mounted on the bearing bracket such that the handle element can be moved between a base position, in which the handle element is flush with the outer contour of a door, and an extended position, in which the handle element protrudes. The handle element covers the closing cylinder in the base position and releases the closing cylinder in the extended position in order to insert a key. The handle element can be moved into the extended position, in which it releases the closing cylinder in order to insert the key, when the handle element is actuated using an extension actuation force.

The invention relates to a motor vehicle handle assembly, comprising a bearing bracket which can be fastened to an inside of a door or tailgate of a motor vehicle, a handle element which is attached to a first pivot arm and a second pivot arm, and a closing cylinder which can be mounted to the motor vehicle handle assembly, wherein the first and the second pivot arms are rotationally fixed to a bearing axis which is rotatably mounted on the bearing bracket and which extends parallel to a longitudinal direction of the handle element, such that the handle element can be moved between a base position, in which the handle element is arranged so as to run flush with the outer contour of a door or tailgate, and an extended position, in which the handle element protrudes from the receiving area of the trough housing relative to the outer contour. The invention is also directed to a method for assembling such a motor vehicle handle assembly.

Motor vehicle handle assemblies of the type mentioned are known and available in different designs. Motor vehicle handle assemblies with movable handle elements and motor vehicle handle assemblies with so-called fixed handle elements are known. While in the case of movable handle elements a portion of the handle element to be gripped from below or from behind by the user is pivoted or moved translationally by force, the handle element cannot be pivoted or moved translationally in the case of fixed door handles. In the case of a motor vehicle handle assembly having a fixed handle element, the handle element is largely immovable relative to the door or tailgate of the motor vehicle. In the absence of a mechanical adjustment path, no continuous mechanical action chain is formed from the handle element to a door lock in motor vehicle handle assemblies with fixed handle elements. Instead, the door lock is controlled electrically as a function of a detected actuation, so that the mechanical hardware can be reduced and costs and weight can be minimized in the motor vehicle handle assembly.

Electric motor vehicle handle assemblies are also known from the prior art, in which a closing cylinder is concealed behind the handle element. In an emergency, the handle element can be lifted from the closing cylinder in these motor vehicle handle assemblies, so that a key can be inserted past the handle element into the closing cylinder in order to mechanically unlock the door lock. However, it is disadvantageous that the closing cylinder is arranged obliquely to the longitudinal axis of the handle element, which makes it difficult to insert the key. Furthermore, the closing cylinder in the known motor vehicle handle assemblies must always be preassembled on the bearing bracket before the bearing bracket is fastened to the inside of the door of the motor vehicle. This mounting assembly proves to be disadvantageous with regard to the anti-theft protection aspect, since it is relatively easy for a thief to “knock” the closing cylinder through the bearing bracket towards the interior of the vehicle with corresponding force and thus to forcefully open the door of the motor vehicle.

The invention is therefore based on the object of developing a motor vehicle handle assembly in a -structurally simple and inexpensive manner which can be manufactured inexpensively, allows for quick and convenient assembly, increases theft security, and allows for convenient handling if the operation of the closing cylinder with a key is required.

This object is achieved according to the invention by a motor vehicle handle assembly with the features according to claim 1.

The motor vehicle handle assembly according to the invention has a bearing bracket which can be fastened to an inside of a door or tailgate of a motor vehicle, a trough housing which can be inserted from an outside of the door or tailgate into a cutout formed in the door or tailgate with a receiving space, a handle element which is attached to a first pivot arm and a second pivot arm, and a closing cylinder, which extends at least in sections within the receiving area and can be mounted on the motor vehicle handle assembly from the outside of the door or tailgate, wherein the first and the second pivot arms are rotationally fixed to a bearing axis which is rotatably mounted on the bearing bracket and which extends parallel to a longitudinal direction of the handle element, such that the handle element can be moved between a base position, in which the handle element is arranged so as to run flush (even or flush-mounted) with the outer contour of a door or tailgate, and an extended position, in which the handle element protrudes from the receiving area of the trough housing relative to the outer contour, wherein the closing cylinder extends perpendicular to the longitudinal direction of the handle element and the handle element covers the closing cylinder in the base position and releases the closing cylinder in order to insert a key in the extended position, wherein a retaining latching device exerts a predetermined retaining force on the handle element in the direction of the base position, and wherein the handle element can be moved into the extended position when the handle element is actuated with an extension actuation force directed away from the bearing bracket that is greater than the predetermined retention force, in which the handle element is arranged to release the closing cylinder in order to insert a key.

The object on which the invention is based is also achieved by a method for assembling a motor vehicle handle assembly having the features according to claim 11.

The method according to the invention is intended for assembling a motor vehicle handle assembly according to claim 1, wherein the bearing bracket is fastened on the inside to the door or tailgate of the motor vehicle, then the first pivot arm and the second pivot arm of the handle element can be connected through the cutout formed on the outside in the door or tailgate to the inside of the bearing bracket, and after connecting the handle element to the bearing bracket, the handle element is actuated with an extension actuation force which is directed away from the bearing bracket and is greater than the predetermined retention force, wherein the handle element is moved in the extended position as a result of the actuation and the handle element is arranged to release the closing cylinder in order to insert a key, wherein the handle element is held in the extended position by the retaining latching device and is thus arranged in a preassembly position in which the closing cylinder is mounted on the motor vehicle handle assembly from the outside of the door or tailgate.

Advantageous and expedient refinements and developments of the invention result from the respective subclaims.

The motor vehicle handle assembly according to the invention has a handle element and a closing cylinder, which are set up and arranged so that they are coordinated with one another in such a way that the closing cylinder is protected and covered by the handle element when no access to the closing cylinder is required. Should the door lock nevertheless have to be unlocked with the help of a key, which can occur, for example, in the event of a system failure of the vehicle electrical system or a de-energized state of the motor vehicle, the handle element can be lifted from the closing cylinder by means of an extension actuation force to be exerted by a user on the closing cylinder in order to insert a key in a convenient and comfortable manner for the user, because according to the invention the closing cylinder is arranged perpendicular to the longitudinal direction of the handle element and the bearing axis, i.e. the closing cylinder extends in its longitudinal direction at an angle of approximately 90° to the longitudinal direction of the handle element and the bearing axis. The fact that the closing cylinder is mounted from the outside of the vehicle door and is thus supported either on the door panel, the trough housing, or the bearing bracket, the security against theft is increased, because it is much more difficult for a thief to break into a motor vehicle to pull out the closing cylinder out of its mounting position, because this is the only way for the thief to manipulate the closing cylinder in the case of this mounting assembly.

In an advantageous embodiment of the motor vehicle handle assembly, the invention provides that sensor electronics are provided for detecting a user-effected actuation of the handle element, and wherein the sensor electronics electrically open the door or tailgate upon detection of an actuation of the handle element by a user with a normal actuation force directed away from the bearing bracket, which is smaller than the predetermined retention force, whereby the handle element remains in its base position. The sensor electronics consequently open the door or tailgate electrically upon detection of an actuation of the handle element by a user using a normal actuation force directed away from the bearing bracket that is less than the predetermined restoring force. Because the normal actuation force is less than the predetermined retention force, the handle element remains arranged in its base position. The handle element is therefore not moved during normal actuation by a user, because the usual normal actuation force is less than the retention force of the retaining latching device. The handle element gives the user the impression of a fixed or quasi-fixed handle element, which is desired by the present invention. In combination with such a fixed handle element, an electrically controlled door lock is used. Such electrically controlled door locks are generally known under the name

“E-Latch.” The manner in which the actuation of the handle element is detected can be solved differently. For the purposes of the invention, switches or capacitive sensors can be used on or in the handle element. The use of inductive sensors is also possible in the sense of the invention. In the sense of the invention, the term “sensor electronics” means both a switch, a button, a capacitive sensor, or an inductive sensor, which is used to detect an actuation of the handle element caused by a user.

In order to increase the stability of the mounting of the handle element designed in the manner of a folding handle on the bearing bracket, the invention provides in a further embodiment that the handle element is attached to a third pivot arm which is rotationally fixed to the at least one bearing axis. The third pivot arm can be arranged between the first and second pivot arm or laterally from the first or the second pivot arm.

In an embodiment of the invention, it is structurally particularly favorable if the retaining latching device has an elastic spring element and a sliding element, wherein the sliding element is motion-coupled to the handle element and a first spring leg of the elastic spring element is supported on the sliding element. For the purposes of the invention, the expression “motion-coupled” is to be understood to mean that the sliding element moves with the handle element when the handle element is actuated by a user and moved out of the base position. Due to the design as an elastic spring element, the restoring force can be set very precisely, which has a positive effect on the extension force to be applied in an emergency. In addition, the use of an elastic spring element is economically advantageous.

In a further embodiment, the invention provides that a second spring leg of the elastic spring element is supported on a support projection which is formed on the bearing bracket or on the trough housing. In the operation of the motor vehicle handle assembly, it is substantial that the second spring leg is supported on a support projection which is stationary with respect to the handle element, so that the elastic spring element can be compressed in accordance with its prescribed mode of action in order to unfold its predetermined force in accordance with the operating state of the motor vehicle handle assembly.

With regard to a structurally simple movement coupling of the handle element and sliding element, the invention provides in a further embodiment that the sliding element is arranged on the first pivot arm or on the second pivot arm so that it can be moved with it. The sliding element can of course also be arranged on a third pivot arm if a third pivot arm is provided. The sliding element can either be attached to a pivot arm or it can be arranged to the side of one of the pivot arms, in which case the sliding element is also attached to the at least one bearing axis and is, for example, motion-coupled to one of the pivot arms via a web.

Normally, the elastic spring element would be compressed when the handle element was moved, so that the force generated by the elastic spring element would increase linearly when compressed. In the sense of the invention, however, it is desirable that the elastic spring element generates an increasing counterforce at the beginning of the movement of the handle element from the base position in the direction of the extended position, wherein this counterforce should decrease abruptly before reaching the extended position, so that the user can comfortably and easily move the handle element to the extended position without using excessive force. Only an initially increased counterforce is desired so that the handle element does not move unintentionally, but consciously. For this purpose, the invention provides in an embodiment that a movement contour is formed on the sliding element, on which the first spring leg of the elastic spring element is supported. The compression of the elastic spring element and thus the counterforce generated by the elastic spring element is determined in accordance with the movement contour.

In a further embodiment, the invention provides that the movement contour is divided into a retaining portion and a latching portion adjoining the retaining portion, and wherein the first spring leg of the elastic spring element is angled and is arranged in the extended position on the latching portion such that the handle element is held latched in its extended position. If there is an emergency, either as a result of a system failure or a power failure, there is consequently the possibility in the motor vehicle handle assembly according to the invention to unlock the door lock with a mechanical key in a very convenient manner for an emergency opening. This is made possible because the handle element can be moved into an extended position in an actuation with an extension actuation force directed away from the bearing bracket, which is greater than the predetermined restoring force, in which the handle element no longer covers the closing cylinder, but rather releases it, so that a key can be inserted into the closing cylinder without the user having to hold the handle element in the extended position. It goes without saying that the extension actuation force must be significantly greater than the normal actuation force, so that a user really only acts on the handle element with a correspondingly large force in an emergency. The motor vehicle handle assembly according to the invention is thus neither to be assigned to the group of motor vehicle handle assemblies with a movable handle nor to the group of motor vehicle handle assemblies with a fixed handle. Rather, the motor vehicle handle assembly according to the invention uses aspects of both groups and is therefore distinguished by a pseudo-fixed handle which remains fixed in its base position during normal operation and which can only be moved into an extended position in an emergency with a correspondingly large extension actuation force, in order to release an unimpeded access to the closing cylinder.

In order for the elastic spring element to generate a non-linear or a continuously increasing counterforce when the handle element moves, the invention provides in a further embodiment that the first spring leg of the elastic spring element moves when the handle element is moved from the base position in the direction of the extended position along the retaining portion, wherein the retention force generated by the elastic spring element increases when the first spring leg of the elastic spring element moves along the retaining portion, and wherein the retention force generated by the elastic spring element when the first spring leg is arranged on the latching portion is smaller than the retention force generated by the elastic spring element when the handle element is arranged in the base position.

Finally, in an embodiment of the motor vehicle handle assembly, the invention provides that the sliding element consists of a plastics material, in particular polyoxymethylene, or of a metal sheet. This configuration allows for a sufficiently desired service life of the sliding element to be achieved.

It goes without saying that the features mentioned above and those to be explained below can be used not only in the combination indicated but also in other combinations or alone, without leaving the scope of this invention. The scope of the invention is defined only by the claims.

Other details, features, and advantages of the subject matter of the invention can be found in the following description in connection with the drawings in which an exemplary and preferred embodiment of the invention is shown.

In the drawings:

FIG. 1 shows a side view of a motor vehicle having a plurality of motor vehicle handle assemblies according to the invention,

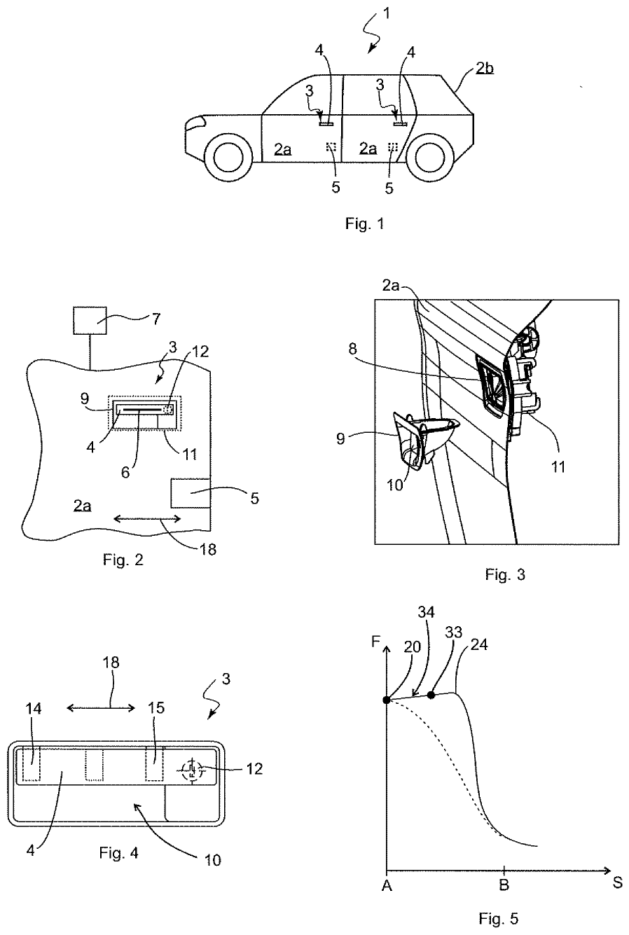

FIG. 2 shows a schematic view of a door of the motor vehicle with a motor vehicle handle assembly,

FIG. 3 shows a perspective view of the door of the motor vehicle, a trough housing which can be inserted on the outside in a cutout in the door, and a bearing bracket which can be fastened on the inside of the door,

FIG. 4 shows a front view of the motor vehicle handle assembly,

FIG. 5 shows a diagram to illustrate the retention force generated by a retaining latching device,

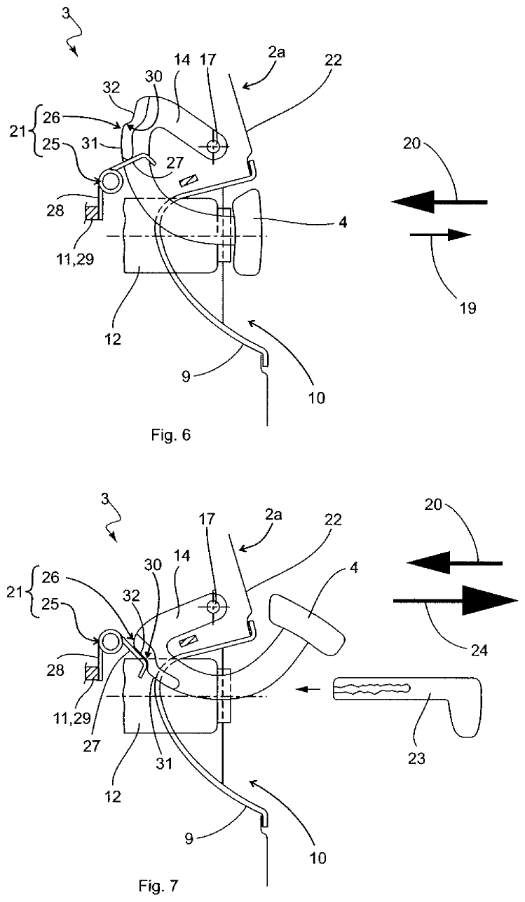

FIG. 6 shows a sectional side view of the motor vehicle handle assembly, in which the handle element is arranged in a base position that is flush with the contour of the door of the motor vehicle, and

FIG. 7 shows a further sectional side view of the motor vehicle handle assembly, in which the handle element is arranged in an extended position protruding from the contour of the door of the motor vehicle.

FIG. 1 shows an example of a vehicle or motor vehicle 1 in the form of a car, which in the example has four doors 2a (two of which can be seen in FIG. 1), which have a motor vehicle handle assembly 3 and in particular can be opened with the aid of a handle element 4. The motor vehicle handle assembly 3 according to the invention can of course also be used for a tailgate 2b, such as a tailgate shown in FIG. 1 or an engine compartment lid or a trunk lid. With reference to FIGS. 1 and 2, the doors 2a are closed by respective door locks 5 and can be opened from the outside by actuating the handle element 4 in each case. The handle element 4 has a handle part that can be gripped from behind, which can be actuated to open the door lock 5, wherein the actuation in the exemplary embodiment illustrated in the figures is a pulling force exerted by the user on the handle element 4, which force is detected by sensor electronics 6 which is built-in in the handle element 4. To open the door 2a (or tailgate 2b), an electromechanical locking system 7 is then activated during normal operation, with the aid of which the door lock 5 can be opened or also closed. The sensor electronics 6 detects a force exerted on the handle element 4 and, upon detection of such a force, opens the door lock 5, wherein with this actuation the handle element 4 remains undeflected on the door 2a and gives the user the impression that it is a fixed handle element 4, which remains fixed in its position or base position despite the application of a pulling force. A wide variety of solutions are known from the prior art for the sensor electronics 6, which can also be used in the motor vehicle handle assembly 3 according to the invention. For example, a switch or button and a capacitive or inductive sensor can be used on or in the handle element 4. Since these are known measures, the sensor electronics 6 are not described in detail.

FIG. 3 is a perspective view of the door 2a of the motor vehicle 1. A cutout 8 formed in the door 2a can be seen in FIG. 3. A trough housing 9 can be inserted into the cutout 8 on the outside, i.e. from the outside of the door 2a, i.e. the trough housing 9 is inserted from the outside into the cutout 8 formed in the door 2a. The trough housing 9 forms a receiving area 10 in which, among other things, the handle element 4 is arranged at least partly. It can also be seen from FIG. 3 that on the inside of the door 2a, i.e. on the interior of the door, a bearing bracket 11 is fastened, which serves, among other things, to store the handle element 4 and a closing cylinder 12 of the motor vehicle handle assembly 3.

FIG. 4 shows a front view of the motor vehicle handle assembly 3, wherein the trough housing 9, the handle element 4, and a closing cylinder 12 hidden by the handle element 4 are shown. The handle element 4 is movably mounted on the bearing bracket 11 via a first pivot arm 14 and a second pivot arm 15, wherein the two pivot arms 14, 15 and the closing cylinder 12 are arranged behind the handle element 4 in FIG. 4. Optionally, a third pivot arm 16 can also be provided, which would further increase the mounting of the handle element 4. In FIG. 4, the third pivot arm 16 is arranged between the first pivot arm 14 and the second pivot arm 15. The first pivot arm 14 and the second pivot arm 15 (and optionally also the third pivot arm 16) are each connected at the end to the handle element 4, whereas the respective other ends of the pivot arms 14, 15 (and possibly 16) are connected in a rotationally fixed manner to a bearing axis 17 which is shown in more detail in FIGS. 6 and 7 (only the first pivot arm 14 is shown in FIGS. 6 and 7), which each show a side sectional view of the motor vehicle handle assembly 3 according to the invention for different positions of the handle element 4. The closing cylinder 12 is arranged laterally from the second pivot arm 15 or on the side of the second pivot arm 15 facing away from the first pivot arm 14, the closing cylinder 12 being attached to the motor vehicle handle assembly 3 on the outside, i.e. from the outside of the door 2a. The closing cylinder 12, which is mounted on the outside or from the outside of the door 2a, can be mounted either on the bearing bracket 11 or the trough housing 9, wherein the closing cylinder 12 can additionally be supported on a body panel of the door 2a. As can also be seen from FIGS. 6 and 7, the closing cylinder 12 extends in sections within the receiving area 10 of the trough housing 9, wherein the pivot arms 14, 15 are substantially horseshoe-shaped. The bearing axis 17, with which the first pivot arm 14 and the second pivot arm 15 (and optionally the third pivot arm 16) are each connected in a rotationally fixed manner, is rotatably mounted on the bearing bracket 11, wherein the bearing bracket 11 is shown only schematically in FIGS. 6 and 7. The bearing axis 17 can be a continuous, single axis with which the pivot arms 14, 15 are connected in a rotationally fixed manner. Alternatively, respective bearing axles could also be provided for each pivot arm 14, 15 (possibly 16), which are mounted on respective pivot bearings. Regardless of this, it is the case with the present invention that the bearing axis 17 extends parallel to a longitudinal direction 18 (see, for example, FIG. 4) of the handle element 4, so that in the present case the handle element 4 is a folding handle which can be gripped from behind by a user for actuation in order to move the handle element 4 from a base position, which is shown in FIG. 6, to an extended position, which is shown in FIG. 7. A movement into the extended position is only intended for emergency operation. As already mentioned above, this is a pseudo-fixed or quasi-fixed handle element 4, in which the sensor electronics 6 detects an actuation of the handle element 4 caused by a user. For normal operation, it is sufficient if the user pulls on the handle element 4 with a normal actuation force 19 directed away from the bearing bracket 11, wherein the normal actuation force 19 (see FIG. 6) is less than a predetermined retention force 20 which is exerted by a retaining latching device 21 on the handle element 4 in the direction of the base position. This is because the normal actuation force 19 is sufficient and is detected by the sensor electronics 6, such that the door 2a (or tailgate 2b) is opened electrically and the handle element 4 remains arranged in its base position. In the base position (see FIG. 6), the handle element 4 is arranged flush with an outer contour 22 of the door 2a, whereas in the extended position (see FIG. 7) the handle element 4 protrudes from the receiving area 10 of the trough housing 9 relative to the outer contour 22 of the door 2a. As can be seen from the overview of FIGS. 2, 4, and 6, the closing cylinder 12 extends perpendicular to the longitudinal direction 18 of the handle element 4, i.e. the closing cylinder 12 extends at an angle of almost 90° to the bearing axis 17, wherein the handle element 4 covers the closing cylinder 12 in its base position (see FIG. 6). In the extended position (see FIG. 7), the handle element 4 which is folded out of the trough housing 9 releases the closing cylinder 12 in order to insert a key 23. In order to move the handle element 4 from the base position into the extended position, the user has to apply an extension actuation force 24 which is directed away from the bearing bracket 11 and which is greater than the predetermined retention force 20.

The retaining latching device 21 has an elastic spring element 25 and a sliding element 26, as shown in FIGS. 6 and 7. The sliding element 26 is motion-coupled to the handle element 4 according to the invention. In the sense of the invention, this means that when the handle element 4 is moved, the sliding element 26 is also moved at the same time. The sliding element 26 can be arranged and fastened on the first pivot arm 14 or on the second pivot arm 15 (or on the third pivot arm 16). However, it is also conceivable for the sliding element 26 to be separated and attached to the bearing axis 17 at a distance from the pivot arms 14, 15 and, for example, to be connected to one or all pivot arms 14, 15 via a web, so that when the handle element 4 moves at the same time the sliding element 26 pivots about the bearing axis 17. In other words, the sliding element 26 is arranged on the first pivot arm 14 or on the second pivot arm 15 so that it can be moved with it. In the exemplary embodiment shown, the sliding element 26 consists of a plastics material, in particular polyoxymethylene (POM), it also being conceivable for the sliding element 26 to consist of a metal sheet. In the exemplary embodiment shown, the elastic spring element 25 is mounted on the bearing bracket 11, it also being conceivable that the elastic spring element 25 is fixed, for example, on the trough housing 9. A first spring leg 27 of the elastic spring element 25 is supported on the sliding element 26, whereas a second spring leg 28 of the elastic spring element 25 is supported on a support projection 29, which is formed on the bearing bracket 11 in the exemplary embodiment shown. Alternatively, the support projection 29 can also be formed on the trough housing 9.

The mode of operation of the motor vehicle handle assembly 3 according to the invention is illustrated by FIG. 5, which shows a diagram in which the actuating force F required to move the handle element 4 over the path S is shown. The dashed line shows a course in which the first spring leg 27 would only be supported on an extension which is arranged on one of the pivot arms 14, 15. The solid line in FIG. 5 stands for the force curve according to the invention, which is achieved with the aid of a movement contour 30 formed on the sliding element 26, on which the first spring leg 27 of the elastic spring element 25 is supported, wherein the first spring leg 27 slides along the movement contour 30 in the direction of the extended position during a movement of the handle element 4. The movement contour 30 is subdivided into a retaining portion 31 and a latching portion 32 adjoining the retaining portion 31, as can be seen in FIGS. 6 and 7. The retaining portion 31 runs on a constant radius with respect to the bearing axis 17, whereas the latching portion 32 has a smaller radius in relation to the bearing axis 17 compared to the radius of the retaining portion 31. If the handle element 4 is actuated in the base position by an operator with the normal actuation force 19, the handle element 4 remains in its base position, since the normal actuation force 19 is smaller than the retention force 20 of the elastic spring element 25. Only when the user applies a movement force 33 that exceeds the retention force 20, the handle element 4 is moved from the base position A (see FIGS. 5 and 6) in the direction of the extended position B (see FIGS. 5 and 7). The elastic spring element 25 is compressed during the movement of the handle element 4 from the base position A in the direction of the extended position B and consequently generates an increasing retention force 34. This increasing retention force 34 prevents an unintentional actuation by a user and is thereby generated by the elastic spring element 25 in that the first spring leg 27 of the elastic spring element 25 moves along the retaining portion 31 when the handle element 4 moves from the base position in the direction of the extended position. As a result, the retention force 20 generated by the elastic spring element 25 increases when the first spring leg 27 of the elastic spring element 25 moves along the retaining portion 31. The retention force 20 generated by the elastic spring element 25 can be 90 Newtons in the base position and can increase to 130 Newtons at the end of the retaining portion 31. At the end of the retaining portion 31, the movement contour 30 of the sliding element 26 has a sudden change in radius on the latching portion 32, the radius of the latching portion 32 being smaller than the radius of the retaining portion 31. This sudden change in radius can also be seen in the course of the line in the diagram in FIG. 5, because the elastic spring element 25 can “relax” and exerts an extension actuation force 24 when the handle element 4 moves into the extended position, which is smaller than that retention force 20 in the base position of the handle element 4. As can be seen from FIG. 6, the first spring leg 27 of the elastic spring element 25 is angled and is arranged in the extended position at the latching portion 32 in such a way that the handle element 4 is held latched in its extended position. When the first spring leg 27 is arranged on the latching portion 32 in the extended position B of the handle element 4, the retention force 20 generated by the elastic spring element 25 is smaller than the retention force 20 generated by the elastic spring element 25 when the handle element 4 is arranged in the base position A.

In the method according to the invention for assembling the motor vehicle handle assembly 3 described above, the bearing bracket 11 is fastened on the inside to the door 2a of the motor vehicle 1 in a first step, wherein then in a second step of the assembly, the first pivot arm 14 and the second pivot arm 15 of the handle element 4 can be connected through the cutout 8 formed on the outside in the door 2a to the inside of the bearing bracket 11. After connecting the handle element 4 to the bearing bracket 11, the handle element 4 is actuated with an extension actuation force 24 which is directed away from the bearing bracket 11 and is greater than the predetermined retention force 20, wherein the handle element 4 is moved in the extended position as a result of the actuation and the handle element 4 is arranged to release the receiving area 10 for mounting the closing cylinder 12. The handle element 4 is held in the extended position by the retaining latching device 21 and is thus arranged in a preassembly position in which the closing cylinder 12 is mounted on the motor vehicle handle assembly 3 from the outside of the door 2a.

Of course, the invention described above is not limited to the described and illustrated embodiment. It can be seen that numerous modifications can be made to the embodiment depicted in the drawing, which are obvious to the person skilled in the art according to the intended application, without leaving the scope of the invention. The invention includes everything that is contained in the description and/or depicted in the drawing, including anything that, deviating from the concrete design example, is obvious to the person skilled in the art.

1. Motor vehicle handle assembly, comprising:
a bearing bracket which can be fastened to an inside of a door or tailgate of a motor vehicle,
a trough housing which can be inserted from an outside of the door or tailgate into a cutout formed in the door or tailgate and has a receiving area,
a handle element which is attached to a first pivot arm and a second pivot arm, and
a closing cylinder which extends at least in sections within the receiving area and can be mounted on the motor vehicle handle assembly from the outside of the door or tailgate,
wherein the first pivot arm and the second pivot arm are rotationally fixed to at least one bearing axis which is rotatably mounted on the bearing bracket and which extends parallel to a longitudinal direction of the handle element, such that the handle element can be moved between a base position in which the handle element is flush with an outer contour of the door or tailgate and an extended position in which the handle element protrudes from the receiving area of the trough housing relative to the outer contour of the door or tailgate,
wherein the closing cylinder extends perpendicular to the longitudinal direction of the handle element and the handle element covers the closing cylinder in the base position and releases the closing cylinder in the extended position in order to insert a key,
wherein a retaining latching device exerts a predetermined retention force in the direction of the base position on the handle element, and
wherein the handle element, upon actuation of the handle element with an extension actuation force directed away from the bearing bracket, which is greater than the predetermined retention force, can be moved into the extended position in which the handle element is arranged to release the closing cylinder in order to insert a key.

2. Motor vehicle handle assembly according to claim 1, wherein sensor electronics are provided for detecting a user-effected actuation of the handle element, and wherein the sensor electronics upon detection of an actuation of the handle element by a user using a normal actuation force directed away from the bearing bracket, which is smaller than the predetermined retention force, electrically open the door or tailgate, whereby the handle element remains in its base position.

3. Motor vehicle handle assembly according to claim 1, wherein the handle element is attached to a third pivot arm which is rotationally fixed to the at least one bearing axis.

4. Motor vehicle handle assembly according to claim 1, wherein the retaining latching device has an elastic spring element and a sliding element, and wherein the sliding element is motion-coupled to the handle element and a first spring leg of the elastic spring element is supported on the sliding element.

5. Motor vehicle handle assembly according to claim 4, wherein a second spring leg of the elastic spring element is supported on a support projection which is formed on the bearing bracket or on the trough housing.

6. Motor vehicle handle assembly according to claim 4, wherein the sliding element on the first pivot arm or on the second pivot arm is arranged to be movable therewith.

7. Motor vehicle handle assembly according to claim 4, wherein a movement contour is formed on the sliding element, on which movement contour the first spring leg of the elastic spring element is supported.

8. Motor vehicle handle assembly according to claim 7, wherein the movement contour is divided into a retaining portion and a latching portion adjoining the retaining portion, and wherein the first spring leg of the elastic spring element is angled and is arranged in the extended position on the latching portion such that the handle element is held latched in its extended position.

9. Motor vehicle handle assembly according to claim 8, wherein the first spring leg of the elastic spring element moves when the handle element is moved from the base position in the direction of the extended position along the retaining portion, wherein the retention force generated by the elastic spring element increases when the first spring leg of the elastic spring element moves along the retaining portion, and wherein the retention force generated by the elastic spring element when the first spring leg is arranged on the latching portion is smaller than the retention force generated by the elastic spring element when the handle element is arranged in the base position.

10. Motor vehicle handle assembly according to claim 4, wherein the sliding element is made of a plastics material, or of a metal sheet.

11. Method for assembling a motor vehicle handle assembly according to claim 1, wherein the bearing bracket is fastened on the inside to the door or tailgate of the motor vehicle, then the first pivot arm and the second pivot arm of the handle element can be connected through the cutout formed on the outside in the door or tailgate to the inside of the bearing bracket, and after connecting the handle element to the bearing bracket, the handle element is actuated using an extension actuation force which is directed away from the bearing bracket and is greater than the predetermined retention force, wherein the handle element is moved in the extended position as a result of the actuation and the handle element is arranged to release the receiving area for mounting the closing cylinder, wherein the handle element is held in the extended position by the retaining latching device and is arranged there in a preassembly position in which the closing cylinder is mounted on the motor vehicle handle assembly from the outside of the door or tailgate.

12. Motor vehicle handle assembly according to claim 10, wherein the sliding element is made of polyoxymethylene.
